(19) United States
(12) Patent Application Publication
(10) Pub. No.: US 2009/0060571 A1
(43) Pub. Date: Mar. 5, 2009

(54) FUSING UNIT AND IMAGE FORMING APPARATUS INCLUDING THE SAME

(75) Inventor: Dong-ju Kang, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/177,342

(22) Filed: Jul. 22, 2008

(30) Foreign Application Priority Data
Aug. 30, 2007 (KR) 2007-87797

(51) Int. Cl. G03G 15/20

(52) U.S. Cl. 399/122; 399/328

(57) ABSTRACT

An image forming apparatus includes a frame, a fusing unit including a unit casing which is detachably attachable to the frame, a heater supported by the unit casing to heat a print medium, a pressure unit supported by the unit casing to press the print medium to the heater and a pressure adjuster provided in the unit casing to relatively move at least one of the pressure unit and the heater with respect to each other to adjust a pressure between the pressure unit and the heater; and a driver which is disposed in the frame to supply a driving force to the pressure adjuster if the fusing unit is attached to the frame.

### CROSS-REFERENCE TO RELATED APPLICATION

This application claims the benefit of Korean Application No. 2007-87797, filed Aug. 30, 2007 in the Korean Intellectual Property Office, the disclosure of which is incorporated herein by reference.

### BACKGROUND OF THE INVENTION

1. Field of the Invention

Aspects of the present invention relate to a fusing unit and an image forming apparatus including the same, and more particularly, to a fusing unit which adjusts an amount of pressure applied to a print medium, and an image forming apparatus including the same.

2. Description of the Related Art

An electrophotographic image forming apparatus forms an image on a print medium through charging, exposing, developing, transferring, and fusing processes. Examples of electrophotographic image forming apparatuses include a laser printer, a photocopier, etc.

An electrophotographic image forming apparatus includes a photosensitive body (not shown), a charging roller (not shown), an exposing unit (not shown), a developing roller (not shown), a transfer roller (not shown) and a fusing unit (not shown).

The charging roller charges a surface of the photosensitive body with a predetermined electric potential. The exposing unit exposes the charged surface of the photosensitive body. Thus, an electrostatic latent image is formed on the surface of the photosensitive body corresponding to image information. The electrostatic latent image is developed with a toner by the developing roller to develop the electrostatic latent image into a toner image.

The transfer roller is disposed in a substantially parallel position with the photosensitive body such that the rotational axes of the transfer roller and photosensitive body are substantially parallel. The transfer roller transfers the toner image to a print medium passing between the photosensitive body and the transfer roller.

The fusing unit includes a heat roller (not shown) to generate heat and a pressure roller (not shown) to press the print medium towards the heat roller. The transferred toner image is fused on the print medium by heat and pressure.

The degree of fusing of the toner image fused on the print medium depends on the amount of pressure applied to the print medium by a pressure roller. Print media include various types, such as general purpose print media including A4, B5 and A3 paper, and specific print media used for specific purposes, such as envelopes, invitation cards and name cards which are relatively thicker than the general purpose print media. A conventional fusing unit has a pressure set based on the general print media. Thus, when print media used for specific purposes, such as envelopes, are printed using a conventional fusing unit, print quality is lower than that of the print quality of the general print media. Particularly, if the print media used for specific purposes are thicker than the general purpose print media, they may be jammed by the pressure set for the general print media.

To solve the foregoing problem, Japanese Patent First Publication No. 1999-265128 discloses a fusing unit which adjusts the pressure applied to a print medium by a pressure roller depending on the thickness of the print medium (hereinafter, to be called “prior art”). The disclosed prior art has a configuration in which both a guide used to guide a print medium entering between a pressure roller and a heat roller, and a pressure lever used to support the pressure roller, are moved depending on the thickness of the print medium.

However, in the prior art, since the pressure roller is supported by the movable pressure lever, the pressure roller may be moved or may not be supported in a stable fashion during a fusing process. Also, if the print medium is jammed in the fusing unit or if the fusing unit needs repairs, the fusing unit cannot be easily detached from a main body of an image forming apparatus. Further, elements such as the pressure lever and the guide, which are used to adjust the pressure of the fusing unit, are attached to the main body, thereby decreasing the ease in which maintenance can be performed.

### SUMMARY OF THE INVENTION

Accordingly, it is an aspect of the present invention to provide a fusing unit which adjusts an amount of pressure applied to a print medium, and an image forming apparatus including the same.

Also, it is another aspect of the present invention to provide a fusing unit which improves maintenance, and an image forming apparatus including the same.

Further, it is another aspect of the present invention to provide a fusing unit which supports a pressure member, such as a pressure roller, in a stable fashion, and an image forming apparatus including the same.

The foregoing and/or other aspects of the present invention are achieved by an image forming apparatus, including a frame, a fusing unit including a unit casing which is detachably attachable to the frame, a heater supported by the unit casing to heat a print medium, a pressure unit supported by the unit casing to press the print medium to the heater, and a pressure adjuster provided in the unit casing to relatively move at least one of the pressure unit and the heater with respect to each other to adjust a pressure between the pressure unit and the heater, and a driver which is disposed in the frame to supply a driving force to the pressure adjuster if the fusing unit is attached to the frame.

According to an aspect of the present invention, the image forming apparatus further includes a controller which controls the driver to adjust the pressure depending on a thickness of the print medium.

According to an aspect of the present invention, the image forming apparatus further includes a first holder which is provided in one of the unit casing and the frame, and a second holder which may be provided in the other one of the unit casing and the frame, and is coupled with the first holder to prevent the unit casing from being separated from the frame if the unit casing is attached to the frame.

According to an aspect of the present invention, the first holder includes a projection which elastically protrudes outwards from the unit casing and retreats inwards towards the unit casing in a transverse direction of an attachment direction of the fusing unit, and an elastic member which elastically biases the projection to make the projection protrude, and the second holder has an insertion hole into which the projection is inserted, and a guide which makes the projection elastically retreat and guides the projection to the insertion hole.

According to an aspect of the present invention, the first holder includes a grip unit to be gripped by a user when the fusing unit is attached and detached to and from the frame.

According to an aspect of the present invention, one of the unit casing and the frame includes a position determining projection formed in the attachment direction of the fusing unit, and the other one of the unit casing and the frame has a position determining hole to insert the position determining projection thereinto.

According to an aspect of the present invention, the pressure adjuster includes a hinge shaft provided on the unit casing, a lever to rotate around the hinge shaft provided on the unit casing, and relatively move one of the pressure unit and the heater to adjust the pressure, and an actuator which receives the driving force from the driver and moves the lever.

According to an aspect of the present invention, the driver includes a driving motor including a driving shaft and a worm gear provided in the driving shaft, wherein the driver transmits the driving force to the pressure adjuster to adjust the pressure by rotating the worm gear by rotating the driving shaft.

According to another aspect of the present invention, the foregoing and/or other aspects of the present invention are also achieved by a fusing unit of an image forming apparatus having a frame, the fusing unit including a unit casing which is detachably attachable to the frame, a heater which is supported by the unit casing to heat a print medium, a pressure unit which is supported by the unit casing to press the print medium to the heater, and a pressure adjuster which is provided in the unit casing to relatively move at least one of the pressure unit and the heater with respect to each other to adjust a pressure between the pressure unit and the heater.

According to another aspect of the present invention, the fusing unit further includes a holder which is provided in the unit casing and which couples the fusing unit to the frame.

According to another aspect of the present invention, the holder includes a pair of projections which are respectively provided on sides of the unit casing to protrude outwards from the unit casing and retreat inwards towards the unit casing, and a pair of elastic members which elastically bias the respective projections to make the projections protrude.

According to another aspect of the present invention, the holder further includes a grip unit to be gripped by a user when the fusing unit is attached and detached to and from the frame.

According to another aspect of the present invention, the frame includes a pair of projections respectively provided on both sides thereof to elastically protrude and retreat, and a pair of elastic members which elastically bias the projections to make the projections protrude, and the holder has a pair of insertion holes into which the projections are inserted, and a pair of guides which make the projections retreat and guide the projections to the insertion holes.

According to another aspect of the present invention, the pressure adjuster includes a hinge shaft provided on the unit casing, a lever which rotates around the hinge shaft provided on the unit casing, and relatively moves one of the pressure unit and the heater, and an actuator which receives a driving force and moves the lever.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic sectional view of an image forming apparatus according to an embodiment of the present invention;

FIG. 2 is a perspective view of a left side of a frame of the image forming apparatus shown in FIG. 1;

FIG. 3 is an enlarged view of a part III shown in FIG. 2;

FIG. 4 is a perspective view of a right side of the frame of the image forming apparatus shown in FIG. 1;

FIG. 5 is an enlarged view of a part V shown in FIG. 4;

FIG. 6 is a schematic view of a fusing unit of the image forming apparatus shown in FIG. 1 before being installed in the frame;

FIG. 7 is a lateral view of the image forming apparatus shown in FIG. 1;

FIG. 8 is a schematic view of the fusing unit of the image forming apparatus shown in FIG. 1 after being installed in the frame;

FIGS. 9 and 10 illustrate a driving process while a solenoid of the image forming apparatus shown in FIG. 1 is turned off and on;

FIG. 11 is a rear view of a driver of the image forming apparatus shown in FIG. 1; and

FIG. 12 is a schematic view of an image forming apparatus according to a second embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

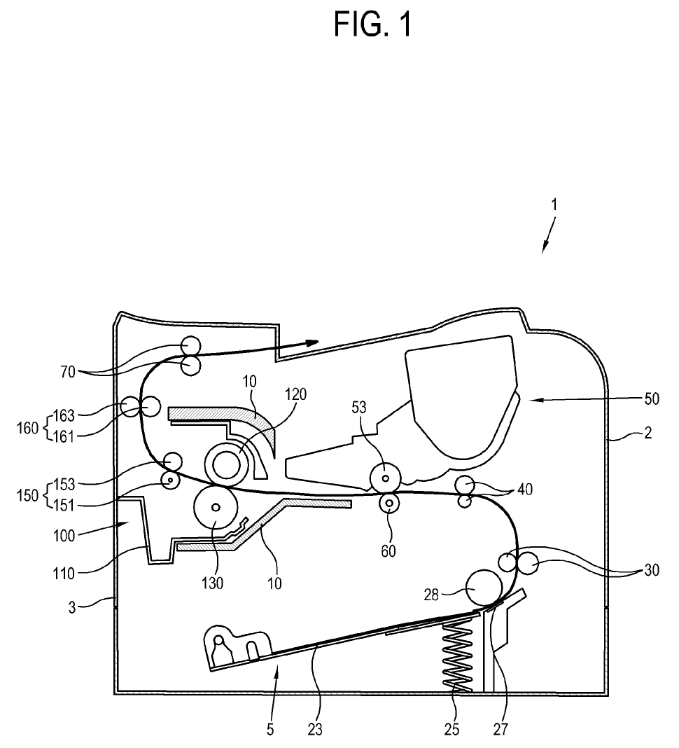

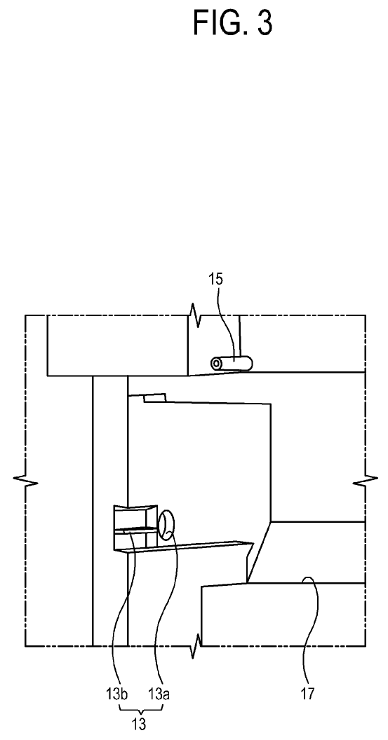

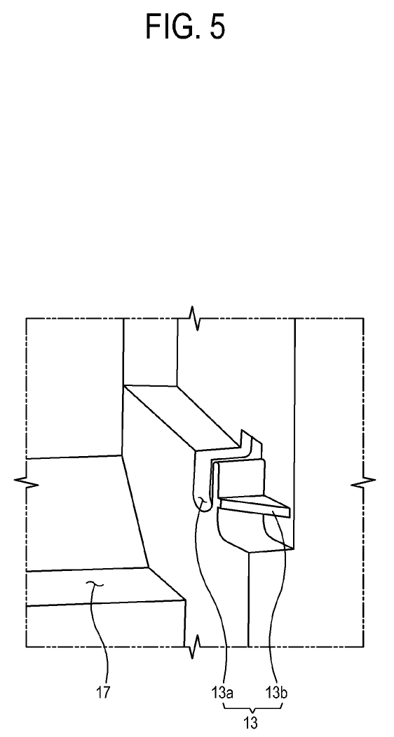

As shown in FIGS. 1 to 6, an image forming apparatus 1 according to an embodiment of the present invention includes a frame 10, a fusing unit 100 and a driver 20 which supplies a driving force to a pressure adjuster 140 of the fusing unit 100. The image forming apparatus 1 further includes a print medium feeding unit 5 to feed a print medium, such as a sheet of 8.5″×11″ paper, a transparency sheet, stationery such as envelopes and cards, recycled paper, letterhead, etc., a moving unit 30, a registration unit 40, a developing cartridge 50 including a photosensitive body 53, a transfer unit 60, a discharging unit 70 and a casing 2 which is used as an external surface to encase the components. A cover 3 may be provided in the casing 2, but is not required to be provided. The cover 3 is opened when a user attaches and detaches the fusing unit 100, and otherwise is closed.

The print medium feeding unit 5 includes a plate 23 to load a print medium thereon, a spring 25 to elastically support the plate 23, a friction pad 27 to prevent a print medium from being overlappingly fed with another print medium, and a pickup roller 28 to pick up a print medium loaded on the plate 23.

The moving unit 30 includes a pair of rollers to move the print medium picked up by the pickup roller 28 to the registration unit 40. The registration unit 40 arranges the print medium and moves the print medium to the photosensitive body 53 and the transfer unit 60 according to a timing mechanism.

The image forming apparatus 1 according to the present embodiment may further include an exposing unit (not shown). The exposing unit exposes a laser beam on a surface of the photosensitive body 53, which has been charged to a uniform electric potential by a charger (not shown), to thereby form an electrostatic latent image thereon corresponding to image information. The electrostatic latent image is developed with a toner by a developing roller (not shown) accommodated in the developing cartridge 50 to develop the electrostatic latent image into a visible image.

The transfer unit 60 transfers the visible image to the print medium passing between the photosensitive body 53 and the transfer unit 60. Thus, a transferred visible image is formed on the print medium. The visible image is fused by heat and pressure while passing the fusing unit 100, and then discharged to the outside by the discharging unit 70.

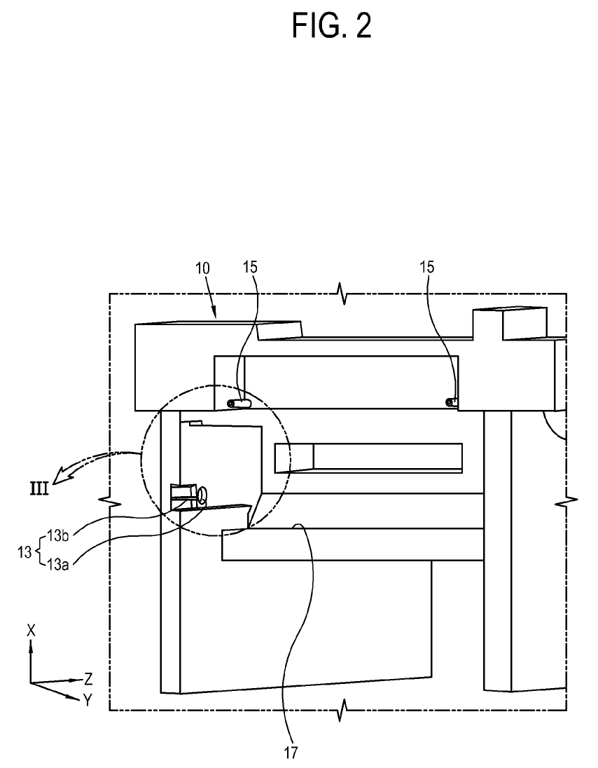

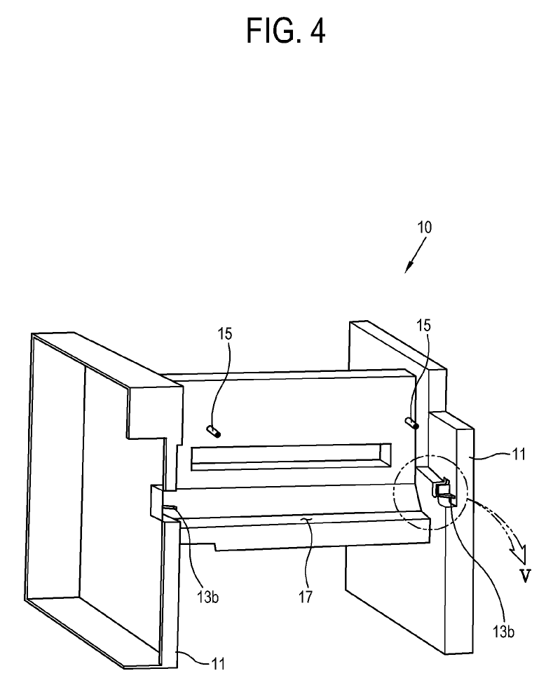

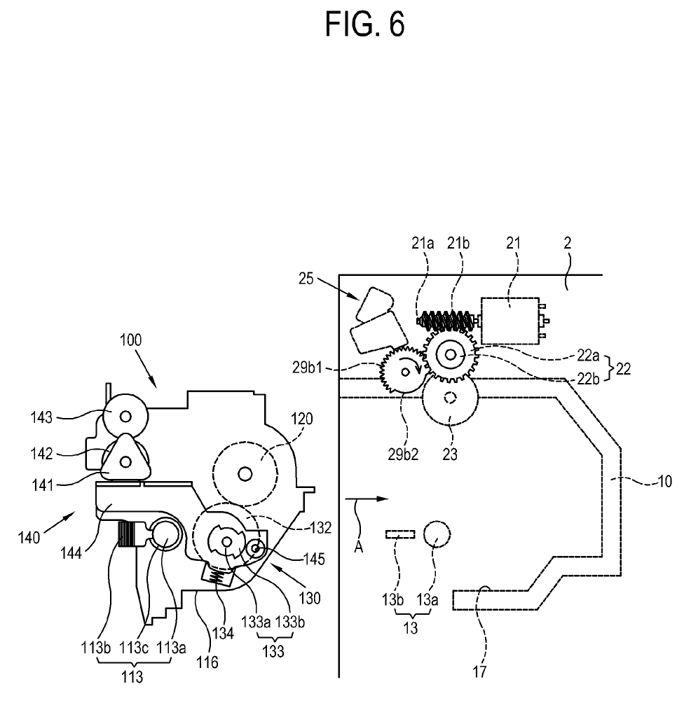

As shown in FIGS. 2 to 5, the frame 10 includes second holders 13 which are held to and coupled with first holders 113 (refer to FIG. 6) of the fusing unit 100 which will be described later. The second holders 13 are provided in side frames 11. The second holders 13 include an insertion hole 13a to insert a projection 113a (refer to FIG. 6) of the first holder 113 thereinto, and a guide 13b which presses and moves the projection 113a backwards to be inserted into the insertion hole 13a. As shown in FIGS. 2 and 4, the guide 13b protrudes inwards in an installation direction A of the fusing unit 100 (refer to FIG. 6). As the projection 113a of the first holder 113 provided in the fusing unit 100 is inserted into the insertion hole 13a, the position of the fusing unit 100 in a direction Z (refer to the xyz axis in FIG. 2) may be controlled.

The first and second holders 113 and 13 are not limited to being provided in the number or locations shown in FIGS. 2-6, and may instead be otherwise provided in the frame 10 and the unit casing 110 as necessary. The shape of the first and second holders 113 and 13 are not limited to the shapes shown in the drawings, and may vary widely, so long as the first and second holders 113 and 13 are capable of detachably attaching the fusing unit 100 to the frame 10.

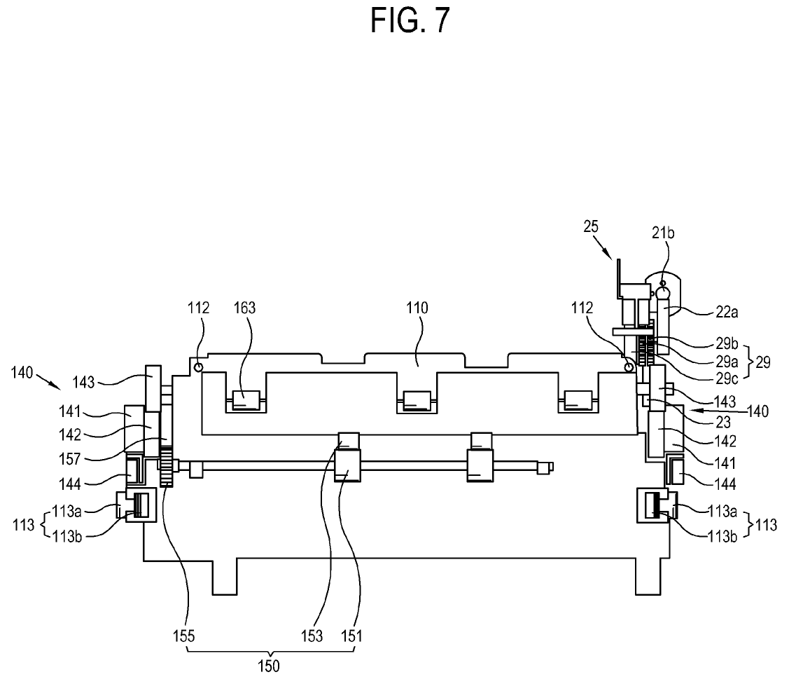

As shown in FIGS. 2 to 4, the frame 10 further includes a plurality of position determining projections 15 which are inserted into corresponding position determining holes 112 (refer to FIGS. 6 and 7) of the fusing unit 100 to determine an installation position of the fusing unit 100. The position determining projection 15 protrudes in the installation direction A (refer to FIG. 6) of the fusing unit 100 to control the position of the fusing unit 100 in the X and Y directions. It is understood that more or less than the two position determining projections 15 shown in FIG. 2 may used according to other aspects of the present invention.

As shown in FIGS. 2 to 5, the frame 10 further includes a lower support 17 which supports a lower surface 116 of the fusing unit 100. Since the lower support 17 controls the position of the fusing unit 100 in the X direction, the position determining projections 15 and the corresponding position determining holes 112 only control the position of the fusing unit 100 in the Y direction.

As shown in FIGS. 6, 9, and 10, the driver 20 includes a driving motor 21, a worm gear 21b, a worm wheel 22, a retardation gear 23, a cam gear 29 and a solenoid 25. The worm gear 21b is provided in a driver shaft 21a of the driving motor 21. The worm wheel 22 includes a first gear 22b which is coupled to the worm gear 21b and a second gear 22a which rotates with the first gear 22b connected to the same shaft. The retardation gear 23 is disposed between the second gear 22a and the cam gear 29 to relay a driving force therebetween.

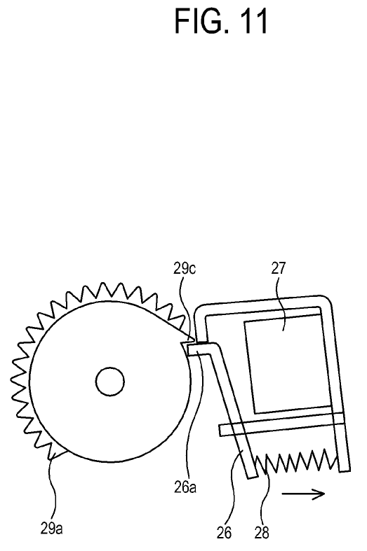

As shown in FIGS. 7 and 11, the cam gear 29 includes a first cam gear 29a, a second cam gear 29b and a latch 29c which are all connected to the same shaft. As shown in FIG. 6, the second cam gear 29b includes a teeth part 29b1 having teeth, and a non-teeth part 29b2 without teeth. According to an aspect of the present invention, the first cam gear 29a has the same shape as the second cam gear 29b. However, it is understood that the first cam gear 29a may instead be shaped differently from the second cam gear 29b.

The cam gear 29 further includes a torsion spring (not shown) which relatively rotates the first cam gear 29a with respect to the second cam gear 29b so that a teeth part (not shown) of the first cam gear 29a rotates clockwise (direction C in FIG. 6) farther than the teeth part 20b1 of the second cam gear 29b. The first cam gear 29a and the latch 29c move integrally. The second cam gear 29b rotates together with the first cam gear 29a after the first cam gear 29a rotates clockwise to a predetermined angle. The first cam gear 29a is coupled to the retardation gear 23 while the second cam gear 29b is coupled to both the retardation gear 23 and a connection gear 143 of the fusing unit 100 (to be described later).

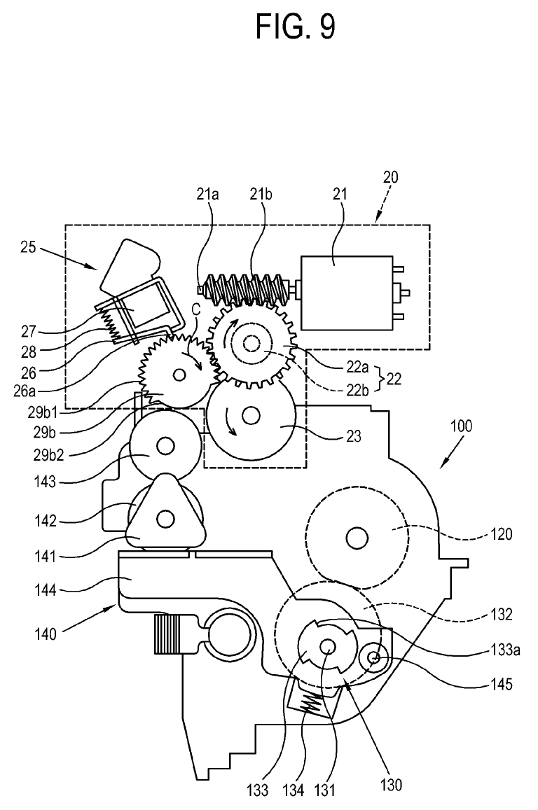

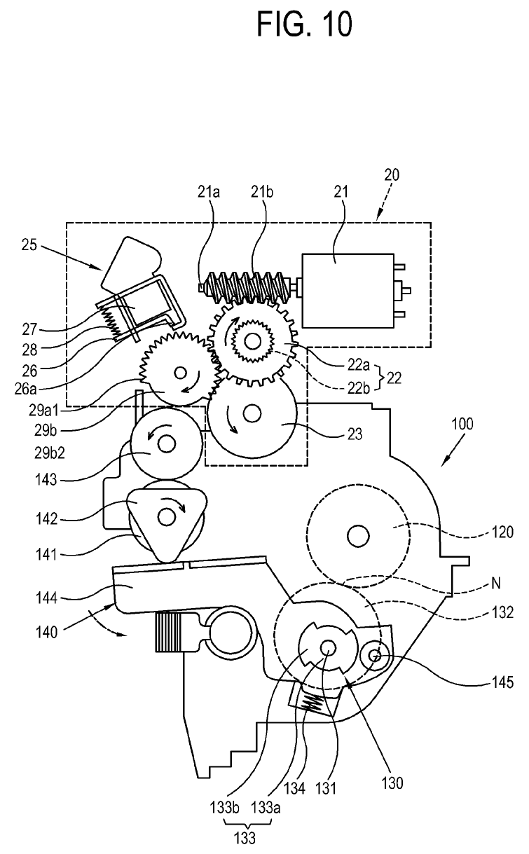

As shown in FIGS. 7 and 9, the solenoid 25 includes a driving piece 26 having a hook 26a, a coil 27 and an elastic member 28 which elastically pulls the end of the driving piece 26 opposite the hook 26a towards the top of the solenoid 25, thereby rotating the driving piece 26 such that the hook 26a catches the latch 29c. When the coil 27 receives power, i.e., if the solenoid 25 is turned on, the driving piece 26 rotates to the coil 27 by electromagnetic force, as shown in FIG. 10. Meanwhile, when power supplied to the coil 27 is cut off, i.e., if the solenoid is turned off, the hook 26a of the driving piece 26 rotates to the cam gear 29 by the elastic force of the elastic member 28. According to an aspect of the present invention, the driving piece 26 is at least partially made of metal.

A process of transmitting rotational force of the retardation gear 23 to the connection gear 143 of the fusing unit 100 through the solenoid 25 and the cam gear 29 will be described with reference to FIG. 9. When power is applied to the coil 27, the latch 29c is released from the hook 26a to rotate the first cam gear 29a clockwise (direction C). Then, the teeth part 29b1 is coupled to the retardation gear 23. The first cam gear 29a rotates clockwise in the direction C and the second cam gear 29b rotates together with the rotation of the first cam gear 29a. The teeth part 29b1 of the second cam gear 29b is coupled to the connection gear 143 to transmit the rotation force to the connection gear 143.

If the second cam gear 29b continues to rotate clockwise and if the non-teeth part 29b2 contacts a surface of the retardation gear 23 as shown in FIG. 9, the rotation force is stopped from being transmitted to the connection gear 143. If power supplied to the coil 27 is cut off, i.e., if the solenoid 25 is turned off, the latch 29c is hooked by the hook 26a such that the latch 29c does not rotate any longer. The first cam gear 29a receives elastic force to rotate clockwise again by the torsion spring.

Although an aspect of the present invention provides the solenoid 25 and the cam gear 29 to transmit the rotational force of the driver 20 provided in the frame 10 to the fusing unit 100, it is understood that the solenoid 25 and the cam gear 29 may be replaced with other typical gears in a variety of configurations to achieve substantially the same effects.

For example, the solenoid 25 and the cam gear 29 may be replaced with a single gear (not shown). The gear is supported by the frame 10 while being coupled to the retardation gear 23, and then coupled to the connection gear 143 when the fusing unit 100 is attached to the frame 10. In this case, the pressure of the fusing unit 100 according to the type of print media may be adjusted by controlling rotations of the driving shaft 21a of the driving motor 21. The worm gear 21b may prevent an actuator driving gear 142 from being released by the elastic member 134 pressing a pressure roller 132. Thus, when the print medium passes the fusing unit 100, the pressure may be consistent by the movement of a lever 144 of the pressure adjuster 140. That is, the adjusted pressure may be maintained while the print medium passes the fusing unit 100.

As shown in FIGS. 1 and 6, the fusing unit 100 includes a unit casing 110, a heater 120, a pressure unit 130 and the pressure adjuster 140. The unit casing 110 supports the heater 120, the pressure unit 130 and the pressure adjuster 140, and is detachably attached to the frame 10.

The unit casing 110 further includes the first holders 113 which are provided in both sides thereof. The first holders 113 are coupled with the second holder 13 provided in the frame 10.

The first holders 113 include the projection 113a, a projection accommodator 113c and an elastic member (not shown). The projection 113a is accommodated in the projection accommodator 113c, protrudes from the unit casing 110 and moves inwards in a transverse direction of the installation direction A.

The elastic member is installed in the projection accommodator 113c, and elastically biases the projection 113a so that the projection 113a protrudes outwards. As shown in FIGS. 6 and 7, the first holders 113 further include a grip unit 113b. The grip unit 113b is provided to move the projection 113a backwards. Preferably, the grip unit 113b extends in an opposite direction of the installation direction A to be easily gripped by a user. When a user moves the grip unit 113b in a direction opposite the direction “A” (FIG. 6), the fusing unit 100 is detached from the frame 10.

According to an aspect of the present invention, the heater 120 includes a heat roller having a heat lamp (not shown) therein. Alternatively, according to other aspects of the present invention, the heater 120 may include a fixed heater such as a ceramic heater instead of a heat roller.

As shown in FIG. 6, the pressure unit 130 includes the pressure roller 132 which faces the heater 120, an elastic member 134 which elastically presses the pressure roller 132 to the heater 120 and a pair of shaft bushings 133 which rotatably support opposite ends of a rotation shaft of the pressure roller 132. The shaft bushings 133 are inserted into the lever 144 (to be described later) and the elastic member 134 presses the pressure roller 132 while being seated in the unit casing 110, thereby supporting the pressure roller 132 in a stable fashion.

The shaft bushings 133 include a circular shaft 133a which supports the rotation shaft of the pressure roller 132, and a rotation force receiver 133b which protrudes from the shaft 133a in a radial direction so that the lever 144 and the pressure roller 132 rotate centering on a hinge shaft 145. The shaft bushings 133 are penetratedly inserted into the lever 144.

As shown in FIG. 6, the pressure adjuster 140 includes the lever 144 which rotates together with the shaft bushings 133 of the pressure unit 130 centering on the hinge shaft 145, and an actuator 141 which receives a driving force from the driver 20 provided in the frame 10 and rotates the lever 144. As shown in FIG. 7, the pressure adjuster 140 may be provided on both sides of the unit casing 110. However, it is understood that the pressure adjuster 140 is not required to be provided on both sides of the unit casing 110, and may instead be provided on only one side of the unit casing 110.

The lever 144 rotates and slides to move the pressure roller 132 with respect to the heater 120. According to an aspect of the present invention, the lever 144 moves the pressure roller 132, but is not limited thereto. Alternatively, the lever 144 may instead move the heater 120 with respect to the pressure roller 132.

As shown in FIG. 6, the actuator 141 includes a cam substantially shaped like a triangle. The shape of the cam is not limited thereto, however, and may vary as long as the cam moves the lever 144 downwards and upwards when the cam is rotated. For example, the shape of the cam may instead be an oval shape. The pressure adjuster 140 further includes the connection gears 143 which receive a driving force from the driver 20 when the fusing unit 100 is attached to the frame 10, and the actuator driving gear 142 which is coupled to the connection gears 143 and drives the actuator 141.

As shown in FIG. 7, the connection gears 143 may be provided on both sides of a rotation shaft 143a. However, it is understood that the connection gears 143 are not limited to being provided on both sides of the rotation shaft 143a, and may instead be provided on a single side of the rotation shaft 143a.

As shown in FIGS. 1 and 7, the fusing unit 100 furthers include a first unit mover 150 and a second unit mover 160. The first and second unit movers 150 and 160 move the print medium, which passes the heater 120 and the pressure unit 130 and has a fused visible image thereon, to the discharging unit 170. It is understood that the fusing unit 100 may instead have only one unit mover or more than two unit movers.

The first unit mover 150 includes an idle roller 153, a driving roller 151, a transmission gear 157 and a roller driving gear 155. The transmission gear 157 and the actuator driving gear 142 are connected to the same shaft to integrally rotate. The roller driving gear 155 is coupled to the transmission gear 157 to drive the driving roller 151. The idle roller 153 is provided in parallel with the driving roller 151, and rotates by contacting the driving roller 151.

The second unit mover 160 includes a driving roller 161 and an idle roller 163, and rotates in the same method as the first unit mover 150 rotates. Thus, detailed descriptions thereof will be omitted.

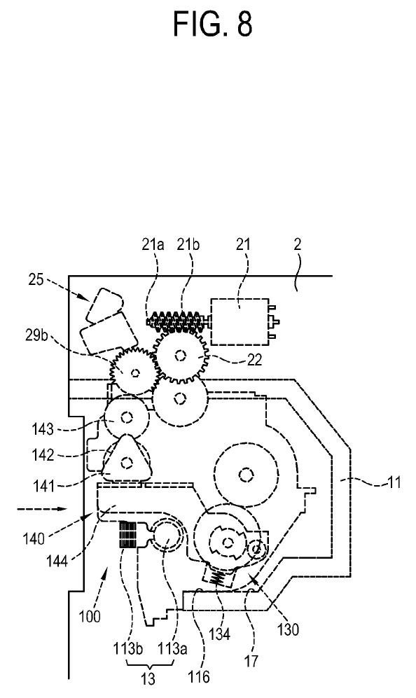

Referring to FIGS. 6 and 8, a process of detaching the fusing unit 100 from the frame 10 will be described hereinafter. When a user grips the unit casing 110 to move the fusing unit in the installation direction A, the lower surface 116 of the unit casing 110 contacts and is supported by the lower support 17 of the frame 10. As the unit casing 110 moves in the installation direction A, the projection 113a of the first holders 113 contacts and elastically moves inwards by the guide 13b of the frame 10, and is inserted into the insertion hole 13a. At the same time, the position determining projection 15 of the frame 10 is inserted into the position determining hole 112 of the unit casing 110. Accordingly, the fusing unit 100 is disposed in the desired installation position.

Conversely, when a user moves the grip unit 113b in an opposite direction of the installation direction A to decouple the projection 113a from the insertion hole 13a, the fusing unit 100 is detached from the frame 10.

Hereinafter, a process of adjusting the pressure of the fusing unit 100 will be described with reference to FIGS. 9 and 10. FIGS. 9 and 10 are schematic views of the fusing unit 100 when the fusing unit is attached to the frame 10 (refer to FIG. 2) and illustrate a driving process while the solenoid 25 is turned off and on, respectively.

The image forming apparatus 1 further includes a controller (not shown) to control the driver 20 and an interface unit (not shown) to transmit and receive print data with respect to a host device (not shown) such as a computer. According to an aspect of the present invention, the interface unit includes at least one of a network interface card, a parallel communication device and a USB communication device to connect the image forming apparatus 1 to a network. It is understood that the interface unit may include only one of these components, such as a network interface card, or may include a combination of these components, such as a network interface card and a parallel communication device.

According to an aspect of the present invention, the host device includes a printer driver to convert original data written by a user with an application program, into print data. The printer driver generates a user interface (UI) to select a type of a print medium to be printed and displays the UI on a monitor (not shown) of the host device. The type of the print medium selected by a user through the UI is transmitted to the controller of the image forming apparatus 1 through the interface unit. Based on the data transmitted by the host device, the controller determines whether the selected print medium includes a general purpose print medium, such as, for example, B5, A4 and A3 size paper, or a print medium used for a specific purpose, such as, for example, an envelope, a name tag, or an invitation card, which are thicker than the general purpose print medium.

The controller determines whether the lever 144 is disposed in a normal position to print the general print medium or in a moving position in which a distance between the pressure roller 132 of the pressure unit 130 and the heater 120 is farther than in the normal position. If the pressure roller 132 is disposed in the moving position, the pressure between the pressure roller 143 and the heater 120 is less than the pressure when the pressure roller 132 is in the normal position.

The image forming apparatus 1 may further include a position detector (not shown) to detect the position of the pressure roller 132. According to aspects of the present invention, the position detector may detect a rotation angle of the actuator driving gear 142 or the position of the lever 144 to detect the position of the pressure roller 132. Also, the position detector may include an encoder or a decoder to detect the number of rotations of the driving motor 21. According to another aspect of the present invention, the position of the pressure roller 132 may be determined by the number of rotations of the driving motor 21. Alternatively, the methods by which the position detector detects the position of the pressure roller 132 may vary according to methods well known in the art.

If the controller determines that the type of the print medium and the position of the lever 144 do not correspond to each other, the controller controls the driver 20 to move the lever 144 to thereby generate a pressure corresponding to the type of the print medium.

For example, the position of the lever 140 in FIG. 9 is the normal position to print a general purpose print medium. If the selected print medium, however, is a print medium for a specific purpose, such as a relatively thick envelope, the controller applies power to the driving motor 21 of the driver 20 and the coil 27 of the solenoid 25. Then, the rotational force of the driving motor 21 is transmitted to the retardation gear 23 through the worm gear 21b and the worm wheel 22.

As shown in FIG. 10, as the hook 26a of the driving piece 26 rotates to the coil 27 due to an electromagnetic attraction, the latch 29c (refer to FIG. 11) is released from the hook 26a of the solenoid 25. Then, the teeth part of the first cam gear 29a is coupled to the retardation gear 23 to transmit the rotational force of the driving motor 21 to the connection gear 143 of the fusing unit 100 through the second cam gear 29b. As the connection gears 143 and the actuator driving gear 142 are driven, the actuator 141 in FIG. 10 rotates in a clockwise direction through a certain angle rotation, such as, for example, a 180° angle rotation, and presses the lever 144 downwards. The pressure roller 132 is then pressed away from the heater 120, and the pressure between the pressure roller 132 and the heater 120 at a contact nip N decreases accordingly. As a result of adjusting the pressure between the pressure roller 132 and the heater 120, the fusing performance may be substantially consistent for the specific purpose print media and the general purpose print media. Particularly, aspects of the present invention maintain a relatively consistent image density formed on different types of print media even when the thicknesses of the print media vary.

The controller cuts off power supplied to the solenoid 25 so that the latch 29c of the cam gear 29 is hooked by the hook 26a. As the first cam gear 29a receives the rotational force, the fusing unit 100 may immediately receive the rotational force if necessary.

If the lower pressure in FIG. 10 is changed to a relatively higher pressure as shown in FIG. 9, power is applied back to the solenoid 25 and the driving motor 21 to transmit the rotational force to the fusing unit 100. Then, the lever 144 moves from the moving position to the normal position.

The types of the print media may be classified according to many different levels of thicknesses, and are not limited to being classified as either the thinner general purpose print media or the thicker specific purpose print media. In this case, the lever 144 rotates to an angle corresponding to the classified print media to adjust the pressure of the fusing unit 100.

As described above, according to an aspect of the present invention, the pressure adjuster 140 maintains a desirable pressure level between the pressure roller 132 and the heater 120 corresponding to the types of the print media until the print media completely passes the heater 120 and the pressure unit 130 of the fusing unit 100. Alternatively, according to another aspect of the present invention, the pressure may be continuously changed while the print medium passes the fusing unit 100. For example, a specific purpose print medium such as an envelope may get wrinkled while passing the fusing unit 100. To prevent this wrinkling, the pressure may be changed while the print medium passes the fusing unit 100.

When the print medium passes the fusing unit 100, the controller may control the driver 20 and the solenoid 25 to continuously change the pressure. If a specific purpose print medium, such as an envelope having an air pocket formed therein, is printed, the pressure may be continuously changed to remove the air from the envelope while the envelope passes the fusing unit 100. This is possible since the lever 144 keeps moving between the normal position in FIG. 9 and the moving position in FIG. 10 while the print medium passes the fusing unit 100. Here, the controller may repeatedly switch the power applied to the solenoid 25 on and off to transmit the driving force of the driving motor 21 to the connection gear 143 of the fusing unit 100. As the actuator 141 rotates and moves the lever 144, the pressure applied between the pressure roller 132 and the heater 120 can be graphically represented as a sine curve moving between the maximum pressure in FIG. 9 and the minimum pressure in FIG. 10.

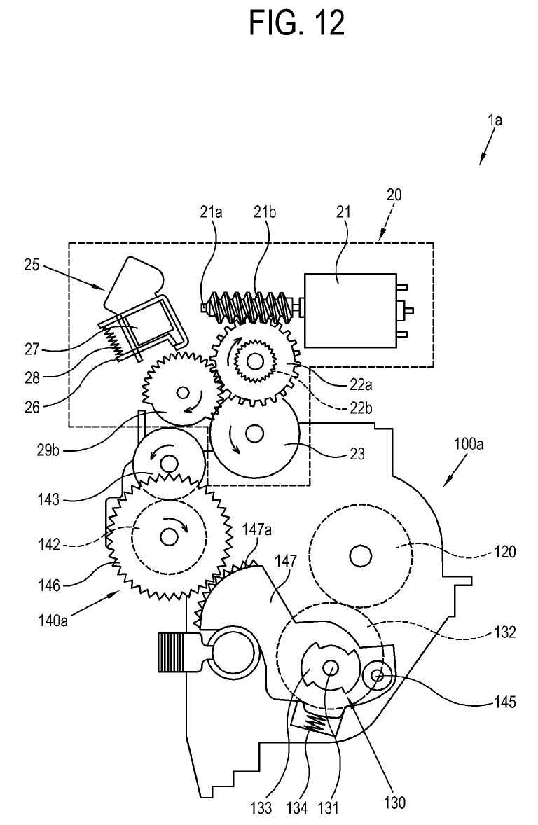

FIG. 12 is a schematic view of an image forming apparatus 1a according to a second embodiment of the present invention. While the actuator 141 according to the first embodiment includes the cam, a second actuator 146 according to the second embodiment includes a gear. A fusing unit 100a according to the second embodiment includes a pressure adjuster 140a. Other elements are equivalent to those elements described above in connection with the first embodiment, and a detailed description thereof will be omitted.

The pressure adjuster 140a includes a connection gear 143, an actuator driving gear 142 which is coupled to the connection gear 143 to drive the second actuator 146, the second actuator 146 and a second lever 147. The second lever 147 includes a second teeth portion 147a to be coupled to the second actuator 146. Other components shown in FIG. 12 are equivalent to those components of the lever 144 according to the first embodiment, and a detailed description thereof will be omitted.

In the pressure adjuster 140a according to the second embodiment, the second actuator 146 and the second lever 147 are connected with each other by a gear to transmit driving force. Thus, a relative position of a pressure roller 132 with respect to a heater 120 may be adjusted more accurately, which is very useful to adjust the pressure depending on the thickness of print media.

Since the second actuator 146 includes the gear, the controller may switch a rotation direction of a driving shaft 21a to change the pressure while the print medium passes the fusing unit 100a.

The fusing unit and the image forming apparatus according to aspects of the present invention provide the following effects. First, an amount of pressure applied between the pressure roller 132 and the heater 120 of the fusing unit 100 may be adjusted depending on a type of a print medium.

Second, since the fusing unit 100 is easily attachable and detachable to and from the image forming apparatus 1, maintenance operations are improved and simplified. Particularly, since a pressure adjuster 140 is attached to a casing 2 of the fusing unit 100, the pressure adjuster 140 may be easily attached to and detached from the image forming apparatus 1 with the fusing unit 100. Thus, the pressure adjuster 140 may be easily maintained.

Third, the pressure roller 132 (or a pressure member which is not necessarily shaped like a roller) of the fusing unit 100 is supported in a stable fashion and fusing performance is improved.

Fourth, aspects of the present invention provide an image forming apparatus and a fusing unit thereof which maintain a relatively consistent image density between different types of print media even when the thicknesses of the print media vary.

Although a few embodiments of the present invention have been shown and described, it would be appreciated by those skilled in the art that changes may be made in this embodiment without departing from the principles and spirit of the invention, the scope of which is defined in the appended claims and their equivalents.

What is claimed is:

1. An image forming apparatus, comprising:
a frame;
a fusing unit, comprising:
a unit casing which is detachably attachable to the frame,
a heater supported by the unit casing to heat a print medium,
a pressure unit supported by the unit casing to press the print medium to the heater, and
a pressure adjuster provided in the unit casing to relatively move at least one of the pressure unit and the heater with respect to each other to adjust a pressure between the pressure unit and the heater; and
a driver which is disposed in the frame to supply a driving force to the pressure adjuster if the fusing unit is attached to the frame.

2. The image forming apparatus according to claim 1, further comprising a controller which controls the driver to adjust the pressure depending on a thickness of the print medium.

3. The image forming apparatus according to claim 1, further comprising a first holder which is provided in one of the unit casing and the frame, and
a second holder which is provided in the other one of the unit casing and the frame, and is coupled with the first holder to prevent the unit casing from being separated from the frame if the unit casing is attached to the frame.

4. The image forming apparatus according to claim 3, wherein the first holder comprises a projection which protrudes outwards from the unit casing and retreats inwards towards the unit casing in a transverse direction of an attachment direction of the fusing unit, and an elastic member which elastically biases the projection to make the projection protrude, and
the second holder has an insertion hole into which the projection is inserted, and a guide which makes the projection retreat and guides the projection to the insertion hole.

5. The image forming apparatus according to claim 4, wherein the first holder further comprises a grip unit to be gripped by a user to make the projection retreat when the fusing unit is attached and detached to and from the frame.

6. The image forming apparatus according to claim 3, wherein one of the unit casing and the frame comprises a position determining projection formed in the attachment direction of the fusing unit, and the other one of the unit casing and the frame has a position determining hole to insert the position determining projection thereinto.

7. The image forming apparatus according to claim 1, wherein the pressure adjuster comprises:
a hinge shaft provided on the unit casing;
a lever to rotate around the hinge shaft provided on the unit casing, and relatively move one of the pressure unit and the heater to adjust the pressure; and
an actuator which receives the driving force from the driver and moves the lever.

8. The image forming apparatus according to claim 7, wherein the driver comprises a driving motor, comprising:
a driving shaft; and
a worm gear provided in the driving shaft to keep the lever rotated.

9. The image forming apparatus according to claim 8, wherein the driver further comprises:
a worm wheel which integrally rotates with a rotation of the worm gear;
a cam gear which rotates with a rotation of the worm wheel, comprising a latch which selectively prevents the cam gear from rotating; and
a solenoid which controls the latch according to an electromagnetic force to control the rotation of the cam gear.

10. The image forming apparatus according to claim 1, wherein the pressure adjustor decreases the pressure when the print medium is relatively thick and increases the pressure when the print medium is relatively thin.

11. The image forming apparatus according to claim 1, wherein the pressure adjustor continuously change the pressure to remove wrinkles from the print medium.

12. A fusing unit of an image forming apparatus having a frame, the fusing unit comprising:
a unit casing which is detachably attachable to the frame;
a heater which is supported by the unit casing to heat a print medium;
a pressure unit which is supported by the unit casing to press the print medium to the heater; and
a pressure adjuster which is provided in the unit casing to relatively move at least one of the pressure unit and the heater with respect to each other to adjust a pressure between the pressure unit and the heater.

13. The fusing unit according to claim 12, further comprising a holder which is provided in the unit casing and which couples the fusing unit to the frame.

14. The fusing unit according to claim 13, wherein the holder comprises a pair of projections which are respectively provided on sides of the unit casing to protrude outwards from the unit casing and retreat inwards towards the unit casing, and a pair of elastic members which elastically bias the respective projections to make the projections protrude.

15. The fusing unit according to claim 15, wherein the holder further comprises a grip unit to be gripped by a user to make the projection retreat when the fusing unit is attached and detached to and from the frame.

16. The fusing unit according to claim 13, wherein the frame comprises a pair of projections respectively provided on sides thereof to protrude and retreat, and a pair of elastic members which elastically bias the respective projections to make the projections protrude, and
the holder has a pair of insertion holes into which the projections are inserted, and a pair of guides which make the projections retreat and guide the projections to the insertion holes.

17. The fusing unit according to claim 12, wherein the pressure adjuster comprises:
a hinge shaft provided on the unit casing;
a lever which rotates around the hinge shaft provided on the unit casing, and relatively moves one of the pressure unit and the heater to adjust the pressure between the pressure unit and the heater; and
an actuator which receives a driving force and moves the lever.

18. The fusing unit according to claim 12, wherein the pressure adjustor adjusts the pressure depending on a thickness of the print medium.

19. The fusing unit according to claim 12, wherein the pressure adjuster continuously changes the pressure to remove wrinkles from the print medium.

20. A detachable fusing unit, comprising:
a unit casing which is detachably attachable to an image forming apparatus;
a heater which is supported by the unit casing to heat a print medium;
a pressure unit which is supported by the unit casing to press the print medium to the heater;
a hinge shaft connected to the unit casing;
a lever connected to the pressure unit and having an end thereof rotatably connected to the hinge shaft; and
an actuator contacting a portion of the lever, wherein the actuator adjusts the pressure between the pressure unit and the heater by moving the portion of the lever to rotate the lever about the hinge shaft.

21. The fusing unit of claim 20, wherein the actuator comprises a cam, the portion of the lever comprises a flat surface portion, and the cam moves the portion of the lever by pushing and releasing the flat surface portion of the lever to adjust the pressure.

22. The fusing unit of claim 20, wherein the actuator comprises teeth parts, the portion of the lever comprises a teeth portion interlocking with the teeth parts, and the actuator moves the portion of the lever by rotating the teeth portion of the lever.
